(19) United States
(12) Patent Application Publication
(10) Pub. No.: US 2018/0313535 A1
(43) Pub. Date: Nov. 1, 2018

(54) COMBUSTION SYSTEM WITH INJECTOR ASSEMBLY INCLUDING AERODYNAMICALLY-SHAPED BODY AND/OR EJECTION ORIFICES

(71) Applicant: Siemens Energy, Inc., Orlando, FL (US)

(72) Inventors: Andrew J. North, Orlando, FL (US); Juan Enrique Portillo Bilbao, Oviedo, FL (US); Walter Ray Laster, Oviedo, FL (US); Domenico Gambacorta, Oviedo, FL (US); Reinhard Schilp, Winter Park, FL (US)

(21) Appl. No.: 15/771,778

(22) PCT Filed: Oct. 28, 2015
(86) PCT No.: PCT/US2015/057792

§ 371 Date: Apr. 27, 2018

(51) Int. Cl. F23D 11/12; F23R 3/34; F23R 3/20; F23D 14/58

(52) U.S. Cl. CPC F23D 11/12; F23R 3/346; F02K 3/10; F23D 14/583; F23R 2900/03341; F23R 3/20

(57) ABSTRACT

An improved combustion system in a combustion turbine engine is provided. The combustor system may include an injector assembly disposed in a combustion stage disposed downstream from a main combustion stage of the combustor system. The injector assembly may include a reactant-guiding structure arranged to deliver to the combustion stage respective jets of reactants through an array of ejection orifices disposed on one or more side walls of the reactant-guiding structure. The reactant-guiding structure may be configured to form a stream-lined body relative to a flow of a fluid to be mixed with the jets of reactants delivered to the combustion stage. The ejection orifices of the array may be aerodynamically-shaped to define a respective stream-lined orifice cross-section, (e.g., airfoil shaped).

### STATEMENT REGARDING FEDERALLY SPONSORED DEVELOPMENT

Development for this invention was supported in part by Contract No. DE-FE0023968, awarded by the United States Department of Energy. Accordingly, the United States Government may have certain rights in this invention.

### FIELD

Disclosed embodiments are generally related to combustion turbine engines, such as gas turbine engines and, more particularly, to injector assemblies disposed in a secondary combustion stage in a distributed combustion system (DCS).

### DESCRIPTION OF THE RELATED ART

In gas turbine engines, fuel is delivered from a fuel source to a combustion section where the fuel is mixed with air and ignited to generate hot combustion products that define working gases. The working gases are directed to a turbine section where they effect rotation of a turbine rotor. It is known that production of NOx emissions from the burning fuel in the combustion section may be reduced by providing a portion of the fuel to be ignited axially downstream from a main combustion stage. This approach is referred to in the art as a distributed combustion system (DCS). See, for example, U.S. Pat. Nos. 8,375,726 and 8,752,386. Each of the above-listed patents is herein incorporated by reference.

### BRIEF DESCRIPTION OF THE DRAWINGS

FIG. 1 is a simplified fragmentary schematic of one non-limiting embodiment of a disclosed combustor system (e.g., a distributed combustion system (DCS)) for a combustion turbine engine, such as a gas turbine engine.

FIGS. 2-3 illustrate schematics of respective non-limiting embodiments of disclosed injector assemblies including a stream-lined reactant-guiding structure (e.g., an aerodynamically-shaped scoop) in combination with an array of aerodynamically-shaped ejection orifices to deliver respective jets of reactants to a combustion stage (e.g., secondary or axial combustion stage) of the DCS.

FIG. 4 illustrates schematic of a non-limiting embodiment of a disclosed injector assembly including a stream-lined reactant-guiding structure (e.g., aerodynamically-shaped scoop) in combination with an array of circular ejection orifices to deliver respective jets of reactants to the axial combustion stage of the DCS.

FIG. 5 illustrates schematic of a non-limiting embodiment of a disclosed injector assembly including a blunt reactant-guiding structure (e.g., circular scoop) in combination with an array of aerodynamically-shaped ejection orifices to deliver respective jets of reactants to the axial combustion stage of the DCS.

FIG. 6 illustrates a schematic of one non-limiting embodiment of a disclosed reactant-guiding structure as may embody a spatially staggered array of ejection orifices.

FIG. 7 illustrates a respective schematic of one non-limiting embodiment of a disclosed reactant-guiding structure, such as an airfoil, including a camber, and further including an array of aerodynamically-shaped ejection orifices.

FIGS. 8-9 illustrate schematics of respective non-limiting embodiments of disclosed reactant-guiding structures as may embody groupings of respective airfoils defining respective cambers including respective arrays of aerodynamically-shaped ejection orifices.

FIG. 10 is a schematic of one non-limiting embodiment of a disclosed aerodynamically-shaped ejection orifice having a profile that decreases in cross-sectional area as the orifice extends towards an exit on the side wall of the reactant-guiding structure.

FIG. 11 is a cross-sectional view of one non-limiting embodiment of a disclosed injector assembly where the reactant-guiding structure may further include a flow passage at the trailing edge of the reactant-guiding structure.

### DETAILED DESCRIPTION

The inventors of the present invention have recognized certain issues that can arise in known distributed combustion systems (DCSs) where injector assemblies disposed in a secondary combustion stage (zone) that may be arranged axially downstream from a main combustion stage generally have a circular cross-sectional profile. These injector assemblies may comprise an assembly of a fuel nozzle fluidly coupled to an air scoop having a blunt (e.g., circular) cross-sectional profile and/or circular-shaped ejection orifices. The secondary combustion stage may also be referred to as an axial combustion stage. For example, the local peak temperatures near these axial-stage injector assemblies (or simply axial injectors) can approach the adiabatic flame temperature of the fuel/air mixture being injected in the secondary combustion stage. This adiabatic temperature can be substantially higher than temperatures in the main combustion stage, resulting in increased localized NOx generation near the axial injectors having the circular cross-sectional profile.

The present inventors have cleverly recognized that one source of elevated local peak temperatures near the injectors with the blunt profile and/or circular-shaped ejection orifices may be the formation of recirculation zones in the leeward side of such injectors where vortex shedding may allow the formation of fuel-rich zones that, for example, can result from relatively low entrainment of primary zone gases in a relatively high combustion residence time. Another source of elevated local temperatures may be a limited opportunity for a head end fluid (e.g., combustion products from the primary combustion zone) to entrain with the axial stage reactants prior to ignition of the axial stage flame resulting from premature ignition of the axial stage reactants due to the flame stabilizing effect of recirculating products in the recirculation zone. Additionally, non-optimized shear generated mixing between the axial stage reactants and primary zone gases can result in elevated flame temperatures due to low dilution of the axial stage reactants prior to ignition of the axial stage flame.

At least in view of the foregoing considerations and without limiting disclosed embodiments to any particular theoretical principle of operation, it is proposed axial injectors structured to eliminate or at least reduce the size of such recirculation zones, and additionally structured to increase the amount of entraining which occurs prior to ignition of the axial stage reactants. In order to reduce recirculation of axial stage reactants in the leeward side of the jet, it is proposed replacing the blunt (e.g., circular) cross section injectors with injectors appropriately (e.g., aerodynamically) configured so that low-pressure regions responsible for the formation of recirculation zones may be replaced by additional axial stage reactants. See patent application (Attorney Docket No. 201515809) titled “Combustion System With Injector Assembly Including An Aerodynamically-Shaped Body”, which is being filed concurrently with the present application and is herein incorporated by reference in its entirety.

The present inventors propose to include an array of aerodynamically configured (e.g., shaped) ejection orifices on one or more side walls of such aerodynamically-shaped injector structures. The present inventors further propose respective combinations, such as a combination of a reactant-guiding structure comprising a stream-lined body (e.g., airfoil-shaped scoop) with an array of aerodynamically-shaped ejection orifices and/or circular-shaped orifices; or a combination of a blunt reactant-guiding structure (e.g., cylindrical-shaped scoop) with an array of aerodynamically-shaped ejection orifices. With the proposed injector structures, in certain non-limiting embodiments, it is now feasible to achieve a reduced combustion residence time, which is conducive to reduce NOx emissions to be within acceptable levels at turbine inlet temperatures of approximately 1700° C. (3200° F.) and higher.

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

The terms “comprising”, “including”, “having”, and the like, as used in the present application, are intended to be synonymous unless otherwise indicated. Lastly, as used herein, the phrases “configured to” or “arranged to” embrace the concept that the feature preceding the phrases “configured to” or “arranged to” is intentionally and specifically designed or made to act or function in a specific way and should not be construed to mean that the feature just has a capability or suitability to act or function in the specified way, unless so indicated.

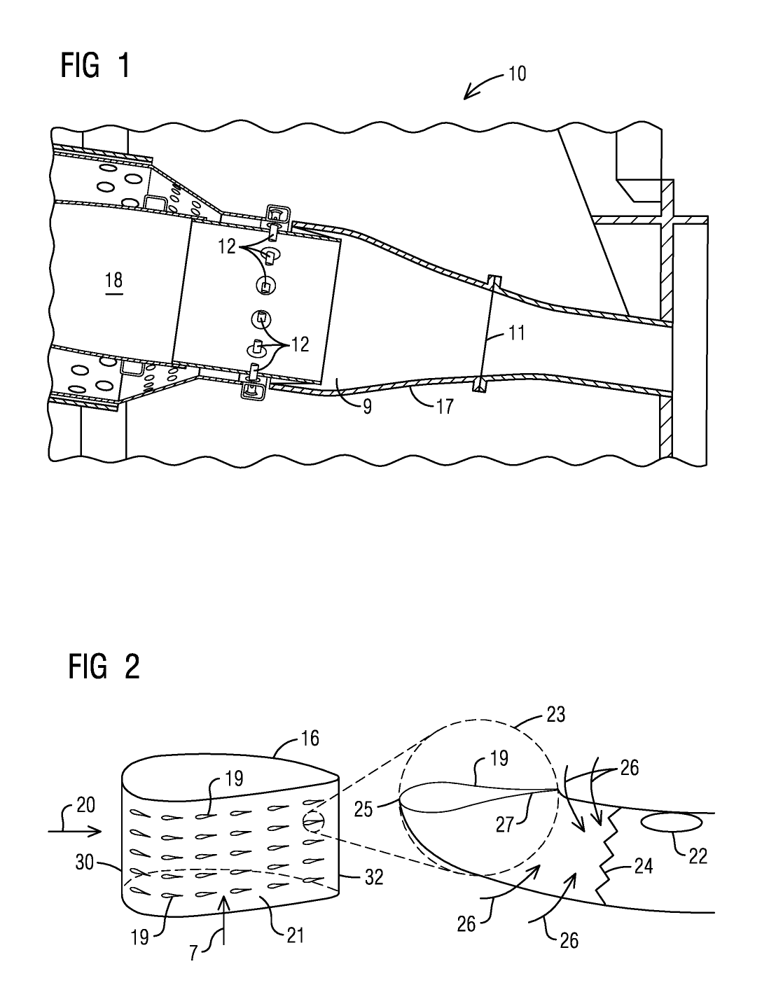

FIG. 1 is a simplified fragmentary schematic of a combustor system 10 (e.g., a DCS) for a combustion turbine engine, such as a gas turbine engine. In one non-limiting embodiment, a plurality of circumferentially-arranged injector assemblies 12 may be disposed in a combustion stage (e.g., axial stage) downstream from a main combustion stage 18 of the combustor system. As shown in FIG. 2, in one non-limiting embodiment, each injector assembly 12 may include a reactant-guiding structure 16 fluidly coupled to receive reactants (e.g., fuel and air, schematically represented by arrow 7). Reactant-guiding structure 16 is arranged to deliver to the combustion stage respective jets of the reactants through an array of ejection orifices 19 disposed on at least one side wall 21 of reactant-guiding structure 16. Ejection orifices 19 may be aerodynamically configured to define a respective stream-lined orifice cross-section (e.g., an airfoil-shaped cross-section). In one non-limiting embodiment, the respective jets of reactants delivered to the combustion stage may define respective tapering cross-sectional profiles relative to the flow of the fluid to be mixed with the reactants.

As will be described in greater detail below, various aerodynamically configured shapes or combinations of such shapes may be used in connection with reactant-guiding structure 16, ejection orifices 19, or both. As may be better appreciated in the inset 23 shown in FIG. 2, in one non-limiting embodiment ejection orifices 19 may be configured to define a curved leading edge 25 and a trading edge comprising a tapering tail section 27.

In one non-limiting embodiment, as may be appreciated in FIG. 2, reactant-guiding structure 16 may be configured to form a streamlined body (e.g., an airfoil or other similar aerodynamically-shaped body) relative to a flow 20 of a fluid (e.g., head end flow) to be mixed with the respective jets of reactants delivered to the axial combustion stage. This streamlined body in combination with the aerodynamically configured ejection orifices 19 may be effective to eliminate or at least reduce the size of the above-described recirculation zones, (schematically represented by oval 22), which in turn avoids or reduces excessive NOx formation rates that can result in a relatively high combustion residence time, and may be further effective to increase the amount of entraining which occurs prior to ignition of the axial stage reactants. For example, formation of the axial stage flame (schematically represented by jagged line 24) is believed to occur incrementally downstream (compared to flame formation involving known blunt (e.g., circular) scoops and/or circular ejection orifices) and this is effective to promote entrainment of the head end fluid with the axial stage reactants (schematically represented by curved fines 26) prior to ignition of the axial stage flame.

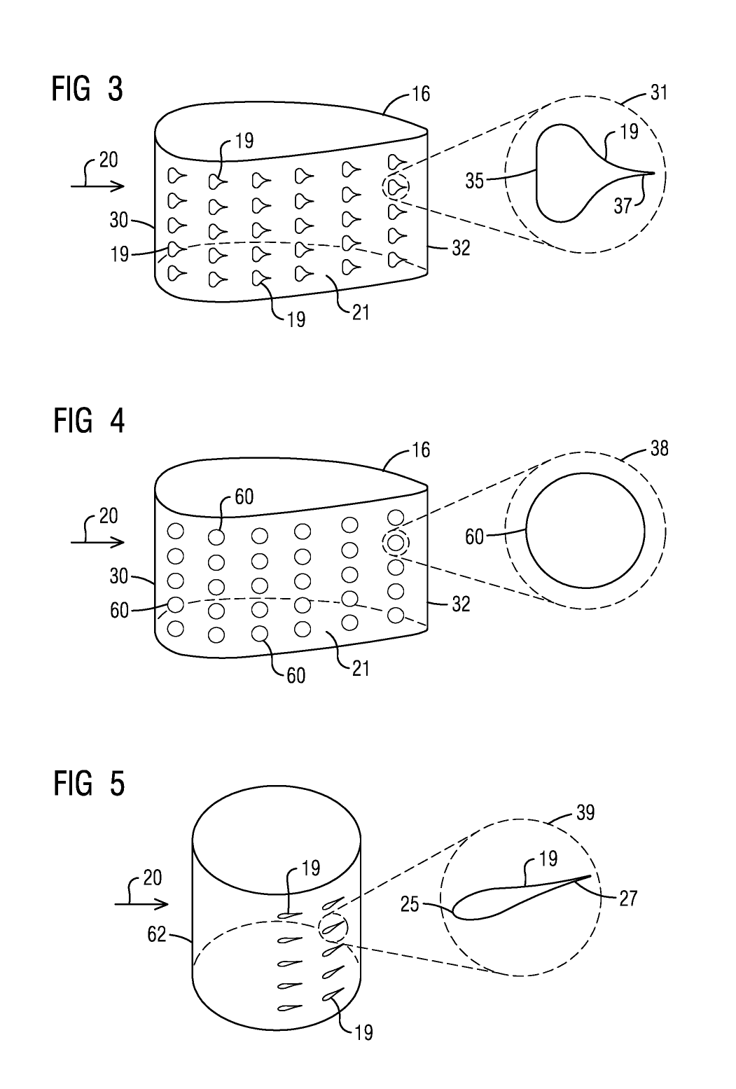

In one non-limiting embodiment, as may be appreciated in FIGS. 2 and 3, reactant-guiding structure 16 may comprise a curved leading edge 30 and a trailing edge comprising a tapering tail section 32. As may be better appreciated in the inset 31 shown in FIG. 3, in one non-limiting embodiment, ejection orifices 19 may be aerodynamically-shaped to define a non-curved leading edge 35 and a trailing edge comprising a tapering tail section 37.

In another non-limiting embodiment, as may be appreciated in FIG. 4, injector assembly may involve stream-lined reactant-guiding structure 16 (e.g., aerodynamically-shaped scoop) in combination with an array of circular ejection orifices 60 (one such ejection orifice 60 is shown in larger detail within inset 38) to deliver the respective jets of reactants to the axial combustion stage of the DCS. Alternatively in yet another non-limiting embodiment, as may be appreciated in FIG. 5, injector assembly may involve a blunt reactant-guiding structure 62 (e.g., a circular scoop) in combination with an array of aerodynamically-shaped orifices 19 (one such ejection orifice 19 is shown in larger detail within inset 39) to deliver respective jets of reactants to the axial combustion stage) of the DCS. It will be appreciated that these combinations may involve tradeoffs regarding ease of manufacturing (e.g., circular ejection orifices or circular scoops compared to aerodynamically-shaped structures) that still may be helpful to reduce the size of the recirculation zones, and increase the amount of entraining which occurs prior to ignition of the axial stage reactants.

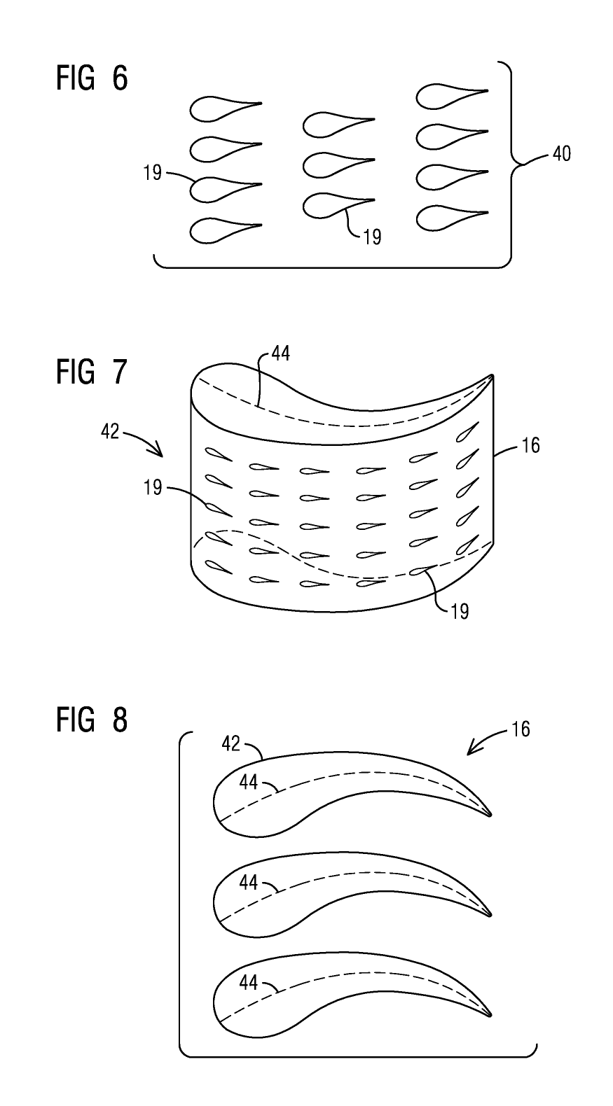

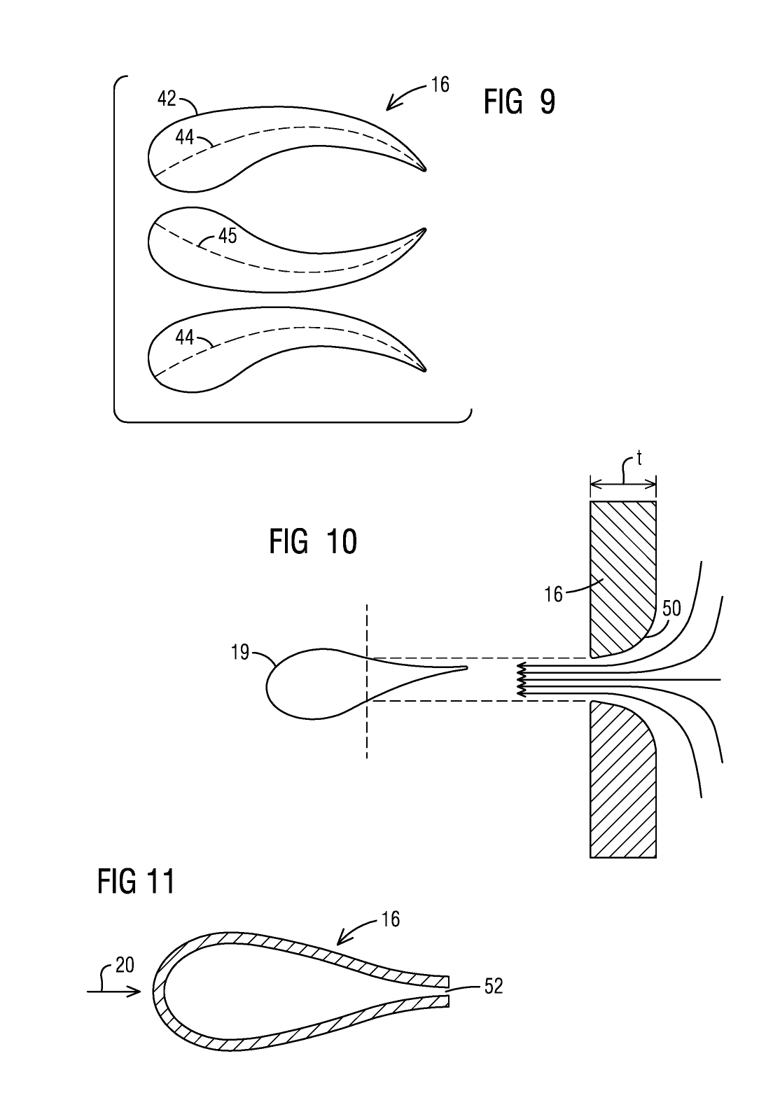

As noted above, it will be appreciated that the respective shapes illustrated in the context of FIGS. 2-5 for the reactant-guiding structures and for the arrays of ejection orifices should not be construed in a limiting sense since one skilled in the art would be able to appropriately tailor such shapes based on the needs of a given application. In one non-limiting embodiment, the tapering tail section (32, 34) of reactant-guiding structure (16) and the respective tapering tail sections (27, 37) of the aerodynamically-shaped ejection orifices 19 may (but need not) be disposed along a downstream direction relative to the flow of the fluid mixed with the jets of reactants. It will be further appreciated that disclosed embodiments need not be construed as mutually exclusive embodiments, since aspects of such disclosed embodiments may be appropriately combined by one skilled in the art depending on the needs of a given application. For example, the arrays of ejection orifices need not consist of a singular shape, size and/or spatial distribution. For example, FIG. 6 illustrates a schematic of one non-limiting embodiment of a disclosed reactant-guiding structure as may embody a spatially staggered array 40 of aerodynamically-shaped ejection orifices 19. This staggered arrangement may be effective to maximize a spatial distribution of heat release.

In yet a further non-limiting embodiment, as may be appreciated in FIG. 7, reactant-guiding structure 16 may comprise an airfoil 42 defining a respective camber 44 and including an array of aerodynamically-shaped ejection orifices 19, such as involving any of the orifice shapes illustrated above. In this embodiment, the array of ejection orifices 19 may be preferably disposed on the suction side of the airfoil. However, at least some ejection orifices 19 could be disposed on the pressure side of the airfoil. This camber configuration may serve to incrementally improve large-scale mixing behavior within the secondary combustion zone. In one non-limiting embodiment, as illustrated in FIG, 8, adjacent airfoils, such as in the plurality of circumferentially arranged injector assemblies, may comprise respective cambers extending along a common direction. If the camber for each reactant-guiding structure 16 is in the same direction, the result would be to create large scale rotation within the flow which can improve mixing behavior. In an alternative non-limiting embodiment, as may be appreciated in FIG, 9, adjacent airfoils may comprise respective cambers 44, 45 extending along alternately varying directions, where, for example, resulting large scale flow features may interact between adjacent axial stage injectors, which in turn may be conducive to promote pre-flame mixing.

In one non-limiting embodiment, as shown in FIG. 10, the velocity gradient of the fluid exiting through ejection orifices 19 (or 60 (FIG. 4)) can be tailored by appropriately altering the progression of the size of the profile through the thickness (t) of the sidewall of reactant-guiding structure 16 (or 62 (FIG. 5)). That is, the cross-section of the aerodynamically-shaped ejection orifice 19 (or circular-shaped ejection orifice 60) may comprise a profile 50 that gradually decreases in cross-sectional area as the orifice extends towards an exit on the side wall of the reactant-guiding structure. This is conceptually analogous to a bell-mouth structure effective to reduce gradients in axial stage velocity, and thus effective to maximize —for a given axial stage volumetric flow rate— the velocity near the wall that defines the ejection orifices 19, 60. In this manner, the velocity gradient between the axial jet and the cross flow near reactant-guiding structure 16 may be effectively increased, thus promoting enhanced mixing between the axial stage reactants and the cross flow. As would be now appreciated by those skilled in the art, the increased velocity near the wall of reactant-guiding structure 16, 62 has an additional benefit of increasing the convection coefficient associated with the axial reactant flow thus improving the cooling effectiveness of this flow. This cooling improvement would reduce the temperature of the walls of reactant-guiding structure 16, 62 which walls are heated on their exterior surfaces by the hot-temperature head end flow which surrounds reactant-guiding structure 16, 62.

In still another embodiment, as shown in FIG. 11, depending on the overall magnitude of axial stage flow rate through reactant-guiding structure 16, in certain situations reduced cooling near the trailing edge of the airfoil could result in relatively higher localized temperatures, and in such situations, a flow passage 52 may be configured at the trailing edge of the airfoil, thereby inducing at least some axial stage flow through the tapering tail section of the airfoil and thus providing incremental cooling to this section and reducing the value of temperatures in this section of the airfoil.

It will be appreciated that each of the above-disclosed axial stage injection embodiments can be applied in traditional secondary combustion zones as well as in applications where the axial combustion stage operates subject to elevated Mach number cross-flows, such as in a flow-accelerating cone 17 (FIG. 1). Based on the narrowing cross-sectional profile of cone 17, as the flow travels from a cone inlet 9 to cone outlet 11, the flow of combustion gases may be accelerated to a relatively high subsonic Mach (M) number, such as without limitation may comprise a range from approximately 0.3 M to approximately a 0.8 M. Accordingly, the combustion gases may flow through cone 17 with an increasing flow speed, and as a result, this flow of combustion gases can experience a decreasing static temperature in cone 17. That is, in one non-limiting embodiment the secondary combustion stage may be located in flow-accelerating cone 17 and injector assemblies 12 may be disposed in flow-accelerating cone 17.

The streamlined shaped scoop in combination with the aerodynamically-shaped ejection orifices has the additional benefit in high subsonic Mach number cross-flows in that the amount of flow blockage in the cross flow path, which occurs as a result of a given volumetric flow of axial stage reactants is reduced over known blunt (e.g., circular) scoop designs. As a result, local unwanted Mach number increases that otherwise would develop due to blocking effects from the presence of such blunt scoops in the path of the flow are reduced. Additionally, the reduced blockage is believed to be effective in minimizing the generation of oblique shock waves in high subsonic Mach number environments.

Increasing the Mach number of the cross flow introduces an additional NOx reduction benefit associated with the reduction in static temperature which accompanies a corresponding increase in the Mach number of the flow. Such static temperature reductions further reduce NOx emissions due to the reduced Arrhenius rate of formation of NOx compounds. For readers desirous of background information in connection with one non-limiting application involving a high Mach number combustion system, see patent application PCT/US2015/041948 filed on Jul. 24, 2015, titled “Combustion System Having A Reduced Combustion Residence Time In A Combustion Turbine Engine”, which is herein incorporated by reference in its entirety.

In operation, disclosed embodiments are expected to be conducive to a combustion system capable of realizing approximately a 65% combined cycle efficiency or greater in a gas turbine engine. Disclosed embodiments are also expected to realize a combustion system capable of maintaining stable operation at turbine inlet temperatures of approximately 1700° C. and higher while maintaining a relatively low level of NOx emissions, and acceptable temperatures in components of the engine without an increase in cooling air consumption.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A combustion system comprising:
an injector assembly disposed in a combustion stage disposed downstream from a main combustion stage of the combustion system, wherein said injector assembly comprises a reactant-guiding structure arranged to deliver to the combustion stage respective jets of reactants through an array of ejection orifices disposed on at least one side wall of the reactant-guiding structure, the reactant-guiding structure configured to form a stream-lined body relative to a flow of a fluid to be mixed with the jets of reactants delivered to the combustion stage, wherein the ejection orifices of the array are aerodynamically-shaped to define a respective stream-lined orifice cross-section.

2. The combustion system of claim 1, wherein the reactant-guiding structure comprises a curved leading edge and a trailing edge comprising a tapering tail section and the cross-section of the aerodynamically-shaped ejection orifice defines a curved leading edge and a trailing edge comprising a tapering tail section.

3. The combustion system of claim 2, wherein the tapering tail section of the reactant-guiding structure and the respective tapering tail sections of the aerodynamically-shaped ejection orifices are disposed along a downstream direction relative to the flow of the fluid mixed with the jets of reactants.

4. The combustion system of claim 3, wherein the tapering tail section of the reactant-guiding structure and the respective tapering tail sections of the aerodynamically-shaped ejection orifices are disposed along a downstream direction relative to the flow of the fluid mixed with the jets of reactants.

5. The combustion system of claim 1, wherein the reactant-guiding structure comprises a curved leading edge and a trailing edge comprising a tapering tail section and the cross-section of the aerodynamically-shaped ejection orifice defines a non-curved leading edge and a trailing edge comprising a tapering tail section.

6. The combustion system of claim 5, wherein the tapering tail section of the reactant-guiding structure and the respective tapering tail sections of the aerodynamically-shaped ejection orifices are disposed along a downstream direction relative to the flow of the fluid mixed with the jets of reactants.

7. The combustion system of any of claim 5, wherein the array of ejection orifices comprises a spatially staggered array of aerodynamically-shaped ejection orifices.

8. The combustion system of claim 1, wherein the reactant-guiding structure comprises an airfoil configured to define a camber and the aerodynamically-shaped ejection orifices are disposed on a suction side of the airfoil.

9. The combustion system of claim 1, comprising further injector assemblies, wherein said injector assembly and the further injector assemblies comprise a plurality of circumferentially arranged injector assemblies in the combustion stage, wherein the respective reactant-guiding structures for the circumferentially arranged injector assemblies comprises air-foils defining a respective camber, wherein adjacent airfoils comprise respective cambers extending along a common direction.

10. The combustion system of claim 1, comprising further injector assemblies, wherein said injector assembly and the further injector assemblies comprise a plurality of circumferentially arranged injector assemblies in the combustion stage, wherein the respective reactant-guiding structures for the circumferentially arranged injector assemblies comprises air-foils comprising respective cambers, wherein adjacent airfoils comprise respective cambers extending along alternately varying directions.

11. The combustion system of claim 1, wherein the cross-section of the aerodynamically-shaped ejection orifice comprises a profile that decreases in cross-sectional area as the orifice extends towards an exit on the at least one side wall of the reactant-guiding structure.

12. The combustion system of claim 1, wherein the combustion stage comprises a flow-accelerating cone, and the injector assembly is disposed in the flow-accelerating cone.

13. The combustion system of claim 1, wherein the respective jets of reactants delivered to the combustion stage comprise respective cross-flow jets relative to the flow of the fluid to be mixed with the reactants.

14. A gas turbine engine comprising a combustion system in accordance with any of the preceding claims.

15. A combustion system comprising:
an injector assembly disposed in a combustion stage disposed downstream from a main combustion stage of the combustor system, wherein said injector assembly comprises a reactant-guiding structure arranged to deliver to the combustion stage respective jets of reactants through an array of aerodynamically-shaped ejection orifices disposed on at least one side wall of the reactant-guiding structure, the reactant-guiding structure configured to form a stream-lined body relative to a flow of a fluid to be mixed with the jets of reactants delivered to the combustion stage, wherein the respective jets of reactants delivered to the combustion stage comprise respective tapering cross-sectional profiles relative to the flow of the fluid to be mixed with the reactants.

16. The combustion system of claim 15, wherein the reactant-guiding structure comprises an airfoil and a cross-section of the aerodynamically-shaped ejection orifice defines a curved or a non-curved leading edge and a trailing edge comprising a tapering tail section.

17. The combustion system of any of claims 16, wherein the tapering tail section of the reactant-guiding structure and the respective tapering tail sections of the aerodynamically-shaped ejection orifices are disposed along a downstream direction relative to the flow of the fluid mixed with the jets of reactants.

18. The combustion system of claim 15, wherein the combustion stage comprises a flow-accelerating cone, and the injector assembly is disposed in the flow-accelerating cone.

19. The combustion system of claim 15, wherein the reactant-guiding structure comprises an airfoil configured to define a camber and the aerodynamically-shaped ejection orifices are disposed on a suction side of the airfoil.

20. The combustion system of claim 15, comprising further injector assemblies, wherein said injector assembly and the further injector assemblies comprise a plurality of circumferentially arranged injector assemblies in the combustion stage, wherein the respective reactant-guiding structures for the circumferentially arranged injector assemblies comprise airfoils defining a respective camber, wherein adjacent airfoils comprise respective cambers extending along a common direction or extending along alternately varying directions.

21. A combustion system comprising:
an injector assembly disposed in a combustion stage disposed downstream from a main combustion stage of the combustion system, wherein said injector assembly comprises a reactant-guiding structure arranged to deliver to the combustion stage respective jets of reactants through an array of ejection orifices disposed on at least one side wall of the reactant-guiding structure, wherein the injector assembly comprises a combination selected from the group consisting of 1) the reactant-guiding structure comprises a stream-lined body relative to a flow of a fluid to be mixed with the jets of reactants delivered to the combustion stage and the array of ejection orifices comprises circular-shaped ejection orifices; 2) the reactant-guiding structure comprises a blunt body relative to the flow of the fluid to be mixed with the jets of reactants and the array of ejection orifices comprises aerodynamically-shaped ejection orifices; and 3) the reactant-guiding structure comprises a stream-lined body relative to the flow of the fluid to be mixed with the jets of reactants and the array of ejection orifices comprises aerodynamically-shaped ejection orifices.

22. The combustion system of claim 21, wherein the combustion stage comprises a flow-accelerating cone, and the injector assembly is disposed in the flow-accelerating cone.
